(19) United States
(12) Patent Application Publication
(10) Pub. No.: US 2014/0344162 A1
(43) Pub. Date: Nov. 20, 2014

(54) METHOD AND SYSTEM FOR ENHANCING THE SECURITY OF ELECTRONIC TRANSACTIONS

(71) Applicant: BANQUE ACCORD, Croix (FR)

(72) Inventors: Benoit Felin, Hallennes-Lez-Haubourdin (FR); Alexis Rizet, Valenciennes (FR)

(21) Appl. No.: 14/122,839

(22) PCT Filed: Apr. 22, 2013
(86) PCT No.: PCT/FR2013/050888

§ 371 Date: Apr. 3, 2014

(30) Foreign Application Priority Data
Apr. 15, 2013 (FR) 13 53407

(51) Int. Cl. G06Q 20/38; G06Q 20/40

(52) U.S. Cl. CPC G06Q 20/3829; G06Q 20/401; G06Q 2220/00
USPC 705/71

(57) ABSTRACT

A method of securing communications between a sales terminal and a server, including the construction by the server and the sales terminal respectively, of a first and second encrypted message; the construction by the sales terminal of a third encrypted message by using the second encrypted message, then its transmission to the server; the deciphering by the server of the third encrypted message by using the first encrypted message; the construction by the server of a fourth encrypted message based on the contents of the third deciphered message by using the first encrypted message, then its transmission to the sales terminal; and the deciphering by the sales terminal of the fourth encrypted message by using the second encrypted message.

The present invention relates to the technical domain of securing communications between a sales terminal and a transaction control server.

Sales terminal is understood hereinafter as any physical or virtual device that enables an electronic transaction to be performed. Non-limiting examples are:
physical sales terminals: sales terminals of transport documents for those involved in transportation (railroad, air, maritime), cash registers on commercial sites (pharmacies, restaurants), cash registers equipped with a self-checking system in some stores (superstores);
virtual sales terminals: e-commerce sites offering services and/or products for sale via a Website and/or a dedicated mobile application.

In order to be able to carry out the transactions, managers of sales terminals deploy or have deployed said terminals at points of sale.

Point of sale (or POS) is understood here as being any physical or virtual location offering the completion of transaction, particularly the sale of products (for example agri-food, pharmaceuticals, multimedia) and/or services (for example deliveries, restaurants, travel, hotels), irrespective of their size or domain of activity.

Following a request for transaction initiated by a user on a sales terminal, said sales terminal can perform a certain number of tasks in order to complete that transaction. In particular, these tasks consist of identifying and recording items (products and/or services) to be billed to the user, informing the user about said transaction, and finally managing the payment.

The task of informing the user about said transaction consists, for example, of furnishing to the user a number identifying the transaction, a number identifying the sales terminal used by the user, a summary of the list of products and/or services involved in the transaction, the amount to be billed to the user or the status of the transaction.

All of the information concerning the transaction can be displayed in accordance with different modes: for example, either virtually on the screen of a payment terminal, or physically on a medium such as a sales receipt.

Irrespective of the mode of displaying (physical or virtual) information concerning the transaction, said information can be displayed in different ways: for example in text form, barcode, tag, QR (“Quick Response”) code, via an NFC-type signal or more generally any type of information coding.

Moreover, in order to guarantee users a convenience of use of sales terminals and therefore a high degree of satisfaction, sales terminals must be able to guarantee support for the most recent technologies. In particular, included among these technologies is support for mobile payment via a mobile terminal belonging to the user and/or the use of a mobile application installed on the user's mobile terminal, in order to interact with the sales terminal preferably via a wireless interface.

As used here, mobile terminal indicates in particular a mobile telephone, a smartphone, a PDA (personal digital assistant) or any other type of communication system capable of recovering information from transactions printed or displayed by a sales terminal and of interacting with a remote server.

For example, this can include remote payment service for vehicle parking by mobile terminal, offering, via the use of different sales terminals, a payment service at destinations of different categories of user terminals. A driver wishing to pay for parking selects a parking zone or rate represented by a code shown on the parking meters or on the Internet, then confirms the vehicle and the desired duration. This solution works on any type of portable telephone. Thus, it is possible to access the service via an Internet browser or via a dedicated smartphone application.

FIG. 1 represents a sales system 10, comprising a sales terminal 1 and a remote transaction control server 2.

Transaction control is understood here as meaning the management (for example reception, verification, authorization, validation) of a list of transmitted items of information (for example identifiers, codes, status of the transaction) that are associated with the transaction.

In the prior art, the method used to conduct a transaction between a sales terminal and a user having a mobile terminal is as follows.

Following a transaction request made by a user having a mobile terminal 4, for example a smartphone, the sales terminal 1 generates and displays a set of items of information related to the transaction (interaction 101), for example in the form of a QR code 5.

With a smartphone 4, the user captures the QR code 5 (interaction 102) via a dedicated application.

Dedicated application is understood here as being an application installed by the user and meeting the needs of a specific service. A user may first have to subscribe to said specific service before being able to use the respective dedicated application. Thus for example, within the scope of an application associated with a payment service, the user must first subscribe to said service and provide a certain amount of personal data about himself, for example his banking identification information. After the user subscribes to the payment service, the dedicated application will then store on the smartphone an encryption key associated with the user's payment card and an encryption key associated with the user's secret code, for future use during a transaction.

It is understood here that the use of a smartphone and a dedicated application to capture a QR code is a non-limiting example, and relates in general to the capture of transaction information by any mobile terminal equipped with an appropriate device.

Once the QR code is captured, the smartphone 4 transmits to the remote transaction control server 2 the captured QR code, identification elements (for example identifiers concerning the smartphone and/or the user), the decryption key of the user's payment card as well as the decryption key of the user's secret code (interaction 103).

Upon receipt of these data, the transaction control server 2 identifies the sales terminal 1 by means of the QR code. It then creates a transaction identifier and inserts into a database 3 a record (interaction 104) containing the elements related to the transaction (for example the identifiers of the smartphone 4 and the sales terminal 1) as well as a code related to the status of the transaction.

The transaction control server 2 then deciphers the data from the user's card by means of the respective decryption key transmitted during interaction 103, then launches a memory process responsible for scanning the code related to the status of the transaction in order to trigger a transaction authorization request at the appropriate time.

The transaction control server 2 then deciphers the user's secret code by means of the respective decryption key transmitted during interaction 103, and generates a first randomized string. Said first randomized string is then concatenated with the user's secret code, then encrypted according to a first cryptographic algorithm. In the end, an encrypted data string called ESC (Encrypted Security Code) is obtained. The ESC string obtained (first encrypted message) is then stored in the database 3 at the level of the transaction (interaction 104).

Said first randomized string is then transmitted by the transaction control server 2 to the sales terminal 1 responsible for the transaction with the user (interaction 105).

Upon receipt of the first randomized string, the sales terminal 1 asks the user to enter his secret code (interaction 106). Said secret code is:
either assumed to be the same as the secret code deciphered by the transaction control server 2;
or more generally tied to the secret code deciphered by the transaction control server 2, i.e., one code can be deduced from the other by applying a specific process to it.

After the secret code is entered and validated by the user (interaction 107), the sales terminal 1 concatenates the entered code with said first randomized string transmitted by interaction 105, then applies the same type of encryption, i.e., uses the same so-called first cryptographic algorithm as the transaction control server 2, in order to generate an ESC string (second encrypted message), which will be designated hereinafter by “entered ESC.”

Interaction 108 allows the sales terminal 1 to communicate the “entered ESC” to the transaction control server 2.

Because the user's secret code transmitted to the sales terminal 1 is assumed to be the same as (or related to) the first secret code decoded at the transaction control server 2, the “entered ESC” obtained is therefore assumed to be the same as the ESC generated by the transaction control server 2.

Upon receipt of the “entered ESC,” the transaction control server 2 compares the “entered ESC” with the ESC that it generated and stored in the database 3. If these two elements are identical, then the user's secret code is correct and the transaction control server 2 then performs the authorization and informs the sales terminal 1 by interaction 109 that it can complete the transaction. Otherwise, it informs the sales terminal 1 by interaction 109 that the code entered by the user is erroneous, so that the user can be asked to reenter his code (interactions 106 and 107) and thus to retransmit a new “entered ESC” to the transaction control server 2 (interaction 108).

The advantage of this method rests essentially on the fact that the same secret code entered during two different transactions leads to two different encrypted strings (of the “entered ESC” type). This makes it possible to guarantee the impossibility of finding a user's secret code.

However, a serious flaw was identified in this method, making it vulnerable to an attack currently known by the name of “Man in the Middle.” This consists in particular of scanning/intercepting the interaction between the transaction control server 2 and the sales terminal 1 (interactions 105, 108 and 109), then simulating the transaction control server 2 via interaction 109 by systematically returning to the sales terminal 1 a positive (or negative) response, irrespective of the “entered ESC” transmitted by interaction 108.

Interaction 109 is particularly critical because it transmits the final response from the transaction control server 2: that is, the response transmitted by said interaction 109, that the sales terminal 1 validates/rejects and/or completes the transaction. One of the limitations of the prior art is therefore found in the vulnerability of interaction 109, particularly if the protocol employed during this interaction can be analyzed and reproduced by an outside individual.

Another flaw makes it possible to use an attack called “brute-force attack” on interaction 108. This method consists of exhaustively testing all possible combinations of characters in order to find at least one item of valid information, in this instance the user's secret code.

Thus, if a hacker has the cryptographic algorithm used by the sales terminal 1 and succeeds in intercepting interaction 108, he will be able, with a “brute-force attack,” to succeed in identifying the user's secret code in the “entered ESC.”

An object of the present invention is to overcome the limitations of the prior art.

Another object of the present invention is to be able to improve the securing of exchanges between a sales terminal and a transaction control server.

To that end, according to a first aspect, the invention relates to a method of securing communications between a sales terminal and a transaction control server, said method comprising
the construction, by the transaction control server, according to a first cryptographic algorithm, of a first encrypted message from at least one first data item;
the construction, by the sales terminal, according to the same said first cryptographic algorithm, of a second encrypted message from at least one second data item, assumed to be the same as said first data item;
   said method further comprising
the construction, by said sales terminal, according to a second encryption algorithm, of a third encrypted message from at least one third data item, by using said second encrypted message as the encryption key;
the transmission, by said sales terminal, of said third encrypted message to said transaction control server;
the deciphering, by said transaction control server, according to said second encryption algorithm, of said third encrypted message, by using said first encrypted message as the decryption key;
the construction, by said transaction control server, according to a third encryption algorithm, of a fourth encrypted message based on the content of said third deciphered message, by using said first encrypted message as the encryption key;
the transmission, by said transaction control server, of said fourth encrypted message to said sales terminal;
the deciphering, by said sales terminal, according to said third encryption algorithm, of said fourth encrypted message, by using said second encrypted message as the decryption key.

According to a second aspect, the invention relates to a transaction control server configured for
constructing, according to a first cryptographic algorithm, a first encrypted message from at least one first data item;
receiving a second encrypted message;
deciphering, according to a second encryption algorithm, said second encrypted message, by using said first encrypted message as the decryption key;
using said first encrypted message as the encryption key, in order to construct, according to a third encryption algorithm, a third encrypted message based on the content of said second deciphered message;
transmitting said third encrypted message.

According to a third aspect, the invention relates to a sales terminal configured for
constructing, according to a first cryptographic algorithm, a first encrypted message from at least one first data item;
using said first encrypted message as the encryption key, in order to construct, according to a second encryption algorithm, a second encrypted message from at least one second data item;
transmitting said second encrypted message;
receiving a third encrypted message;
deciphering, according to a third encryption algorithm, said third encrypted message, by using said first encrypted message as the decryption key;
authorizing or completing a transaction based on said third deciphered message.

According to a fourth aspect, the invention relates to a system for securing communications between a sales terminal and a transaction control server, said system comprising
a transaction control server configured for constructing, according to a first cryptographic algorithm, a first encrypted message from at least one first data item;
a sales terminal configured for constructing, according to the same said first cryptographic algorithm, a second encrypted message from at least one second data item, assumed to be the same as said first data item;
said system further comprising
the sales terminal configured for constructing, according to a second encryption algorithm, a third encrypted message from at least one third data item, by using said second encrypted message as the encryption key;
the sales terminal configured for transmitting said third encrypted message to said transaction control server;
the transaction control server configured for deciphering, according to said second encryption algorithm, said third encrypted message, by using said first encrypted message as the decryption key;
the transaction control server configured for constructing, according to a third encryption algorithm, a fourth encrypted message based on the content of said third encrypted message, by using said first encrypted message as the encryption key;
the transaction control server configured for transmitting said fourth encrypted message to said sales terminal;
the sales terminal configured for deciphering, according to said third encryption algorithm, said fourth encrypted message, by using said second encrypted message as the decryption key.

According to a fifth aspect, the invention relates to a computer program product implemented on a storage medium, capable of being run on an electronic data processing unit and comprising instructions for the implementation of the method summarized above.

Other characteristics and advantages of the invention will appear more clearly and in more detail from the following description of preferred embodiments, provided with reference to the appended FIG. 1, which diagrammatically illustrates the context of implementation of one embodiment.

The present invention proposes to enhance the content of the QR code 5 transmitted by interactions 101, 102, 103 and to modify the content of exchanges transmitted by interactions 108 and 109.

Following a transaction request made by a user having a mobile terminal 4, for example a smartphone, the sales terminal 1 generates and displays a set of items of information related to the transaction (interaction 101), for example in the form of a QR code 5.

All of the information that is generated, then displayed, comprises information related to the transaction, including at least one item of identification information furnished by the sales terminal 1.

In general, the identification information furnished by the sales terminal 1 consists of any information agreed to in advance between the sales terminal 1 and the transaction control server 2, or any other information known to both sides.

For example, the identification information furnished by the sales terminal 1 can include an authentication token and/or an IP address that are known by the transaction control server 2.

This identification information will then be completed by a randomized string composed of a series of random characters generated by the sales terminal 1.

Said randomized string shall hereinafter be designated “second randomized string,” in order to distinguish it from the first randomized string generated at the transaction control server 2, during the construction of the first encrypted ESC message.

In one embodiment, the sales terminal 1 generates and displays a set of items of information (interaction 101), for example in the form of a QR code 5, formed from an authentication token known to the transaction control server 2, said authentication token being completed by a series of random characters generated by the sales terminal 1.

The QR code 5, and more generally all of the items of information displayed by the sales terminal 1 (interaction 101), captured by the mobile terminal 4 (interaction 102) and transmitted to the transaction control server 2 (interaction 103) have their contents enhanced by the presence of the second randomized string added by the sales terminal 1.

Upon receipt of the QR code 5, the transaction control server 2 separates the QR code 5 into two parts:
the part containing the additional information, in this instance the authentication token that will serve to identify the sales terminal;
the part containing the second randomized string that has been added by the sales terminal 1.

The construction of a first encrypted message by the transaction control server 2 comprises:
the generation of a first randomized string by the transaction control server 2;
the concatenation of the user's secret code deciphered with said first randomized string;
the use of a first cryptographic algorithm in order to encrypt the concatenated first randomized string and the secret code.

In one embodiment, the part of the QR code 5 containing said second randomized string will make it possible to complete the construction of said first encrypted message:

Said first randomized string generated by the transaction control server 2 is concatenated with the user's secret code, then concatenated with said second randomized string contained in the QR code 5. The string obtained is finally encrypted according to a first cryptographic algorithm. The first encrypted message corresponding to the ESC is thus obtained.

Similarly, after the entry and validation of the secret code by the user (interaction 107), the sales terminal 1 concatenates the entered code with said first randomized string transmitted by interaction 105, then with said second randomized string that it has generated. It then applies the same type of encryption, i.e., it uses the same so-called first cryptographic algorithm as the transaction control server 2 in order to generate the second encrypted message corresponding to the “entered ESC.”

One advantage of using a second randomized string for constructing ESC and “entered ESC” (respectively first and second encrypted messages) lies in the complexity of these messages. More particularly in terms of technical effect, this makes it possible to reinforce the entropy of these messages: the number of combinations to be tested for a “brute-force” type of attack on interaction 108 becomes particularly large. Thus, even if a hacker has the cryptographic algorithm employed for the construction of these messages, the presence of two randomized strings make such a method very complex, even nearly impossible, to be implemented because of the number of combinations to be tested.

Another advantage is that, contrary to the first randomized string transmitted by interaction 105, the second randomized string is not transmitted directly between the transaction control server 2 and the sales terminal 1. Thus, even if a hacker succeeds in intercepting interaction 105 containing the first randomized string, and has the cryptographic algorithm that the sales terminal 1 uses, the presence of said second randomized string would limit the risk of a “brute-force” type of attack.

Said “entered ESC” is then employed as the encryption key during a second encryption algorithm to construct a new message (third encrypted message). Said third encrypted message is composed of a randomized string that contains the identifier of the sales terminal 1 at certain known positions of the sales terminal 1 and of the transaction control server 2.

Said third encrypted message constructed by the sales terminal 1 is then transmitted (interaction 108) to the transaction control server 2.

After receipt of said third message, the transaction control server 2 uses the ESC that it has stored in the database 3 as the decryption key based on the same so-called second encryption algorithm, to decipher the message received, by using its knowledge of the positions of the identifier of the terminal. If the identifier of the sales terminal 1 is found in the deciphered message, then the secret code entered by the user, transmitted during interaction 107, is correct. Otherwise, if the identifier of the sales terminal 1 is not found in the deciphered message, this means that the “entered ESC” differs from the ESC stored in the database 3 and the code entered by the user is therefore incorrect.

It should be noted here that the use of the identifier of the sales terminal 1 in constructing the third encrypted message, of the positions of said identifier and its recognition during the deciphering of said third encrypted message, is provided by way of non-limiting example. In general, it is possible to use any other information agreed to in advance between the sales terminal 1 and the transaction control server 2, or any other information known to both sides. An example of other information would be the IP address of the sales terminal 1.

The transaction control server 2 then generates a control message based on the contents of said deciphered message. Said control message is composed of a randomized string in which the transaction control server 2 is going to place, at positions known to the sales terminal 1 and to itself, a transaction instruction code designated here by “return code” of the transaction. By way of example, the “return code” is an encoded message associated with the status of the transaction: “OK” if the transaction is validated, or “KO” if it is not.

Said control message is then encrypted by means of the ESC stored in the database 3 according to a third encryption algorithm (obtaining a fourth encrypted message), then transmitted to the point of sale 1 by interaction 109.

Upon receipt of said fourth encrypted message, the point of sale 1 uses the “entered ESC” as the decryption key based on the same so-called third encryption algorithm, in order to decipher said fourth encrypted message. Said deciphered message thus corresponds to said control message. The point of sale then extracts from said control message the “return code” of the transaction by using its knowledge of the positions of said “return code.”

If said extracted “return code” is determined to be coherent by the sales terminal 1, this means that the secret code entered by the user is correct. The authorization and/or completion of transaction are then carried out based on the contents of said “return code.” For example, the presence of an encoded message associated with the status “OK” or “KO” of a transaction can be verified in the “return code.”

Otherwise, the user is asked to reenter his secret code (interactions 106 and 107) so that it can be retransmitted.

Moreover, in the event an erroneous secret code is entered by the user, the probability that the “entered ESC” can enable the control message (transmitted by interaction 109) to be deciphered in order to extract a coherent “return code” from it depends on the length of the items of information to be controlled.

An example of items of information to be controlled is the length of the “return code” of the transaction present in said control message.

Thus, in one embodiment, it is agreed to construct a “return code” that is long enough that the probability of extracting a coherent “return code” is nearly zero if the secret code of the user is erroneous.

Advantageously, said “return code” can be completed during its construction by CRC 32-type control bytes.

Advantageously, an intruder listening to the messages exchanged between the sales terminal 1 and the transaction control server 2 cannot succeed in constructing a message notifying, by interaction 109, the sales terminal 1 that it can favorably (or unfavorably) complete the transaction.

Another advantage of this invention is that two identical codes entered on the same sales terminal 1 result in the construction of two different messages during the same transaction; it is therefore impossible for an intruder to analyze the protocol employed.

Advantageously, the method just described makes it possible:
to improve the securing of electronic transactions;
to reinforce the securing of exchanges performed between a transaction control server and a sales terminal;
to improve the contents of exchanges between a transaction control server and a sales terminal, without however modifying their respective interactions;
to prevent any outside analysis of the protocols used;
to prevent any “brute-force” type of attack;
to limit any risk of “Man in the Middle” type of attacks.

1. A method of securing communications between a sales terminal and a transaction control server, said method comprising
the construction, by the transaction control server, according to a first cryptographic algorithm, of a first encrypted message from at least one first data item;
the construction, by the sales terminal, according to the same said first cryptographic algorithm, of a second encrypted message from at least one second data item, assumed to be the same as said first data item;
said method characterized in that it further comprises
the construction, by said sales terminal, according to a second encryption algorithm, of a third encrypted message from at least one third data item, by using said second encrypted message as the encryption key;
the transmission, by said sales terminal, of said third encrypted message to said transaction control server;
the deciphering, by said transaction control server, according to said second encryption algorithm, of said third encrypted message, by using said first encrypted message as the decryption key;
the construction, by said transaction control server, according to a third encryption algorithm, of a fourth encrypted message based on the content of said third deciphered message, by using said first encrypted message as the encryption key;
the transmission, by said transaction control server, of said fourth encrypted message to said sales terminal;
the deciphering, by said sales terminal, according to said third encryption algorithm, of said fourth encrypted message, by using said second encrypted message as the decryption key.

2. The method according to claim 1, further comprising a step of authorizing or completing a transaction by said sales terminal, based on said fourth deciphered message.

3. The method according to claim 1, wherein said third data item includes a randomized string containing, at positions known to the sales terminal and the transaction control server, an item of information agreed to in advance between the sales terminal and the transaction control server.

4. The method according to claim 1, wherein the construction of said fourth encrypted message includes the encryption of a randomized string containing, at positions known to the sales terminal and the transaction control server, a transaction return code.

5. The method according to claim 1, wherein said return code is completed by control bytes during its construction.

6. The method according to claim 1, wherein said first data item and said second data item correspond to a user's secret code.

7. The method according to claim 1, wherein said first data item and said second data item comprise the same randomized string.

8. A transaction control server configured for:
constructing, according to a first cryptographic algorithm, a first encrypted message from at least one first data item;
receiving a second encrypted message;
deciphering, according to a second encryption algorithm, said second encrypted message, by using said first encrypted message as the decryption key;
using said first encrypted message as the encryption key, in order to construct, according to a third encryption algorithm, a third encrypted message based on the content of said second deciphered message;
transmitting said third encrypted message.

9. A sales terminal configured for
constructing, according to a first cryptographic algorithm, a first encrypted message from at least one first data item;
using said first encrypted message as the encryption key, in order to construct, according to a second encryption algorithm, a second encrypted message from at least one second data item;
transmitting said second encrypted message;
receiving a third encrypted message;
deciphering, according to a third encryption algorithm, said third encrypted message, by using said first encrypted message as the decryption key;
authorizing or completing a transaction based on said third deciphered message.

10. A system for securing communications between a sales terminal and a transaction control server, said system comprising
a transaction control server configured for constructing, according to a first cryptographic algorithm, a first encrypted message from at least one first data item;
a sales terminal configured for constructing, according to the same said first cryptographic algorithm, a second encrypted message from at least one second data item, assumed to be the same as said first data item;
said system characterized in that it further comprises
the sales terminal configured for constructing, according to a second encryption algorithm, a third encrypted message from at least one third data item, by using said second encrypted message as the encryption key;
the sales terminal configured for transmitting said third encrypted message to said transaction control server;
the transaction control server configured for deciphering, according to said second encryption algorithm, said third encrypted message, by using said first encrypted message as the decryption key;
the transaction control server configured for constructing, according to a third encryption algorithm, a fourth encrypted message based on the content of said third encrypted message, by using said first encrypted message as the encryption key;
the transaction control server configured for transmitting said fourth encrypted message to said sales terminal;
the sales terminal configured for deciphering, according to said third encryption algorithm, said fourth encrypted message, by using said second encrypted message as the decryption key.

11. The system according to claim 1 wherein the sales terminal is further configured to apply a step of authorization or of completion of transaction based on said fourth deciphered message.

12. A computer program product implemented on a storage medium, capable of being run on a data processing unit and comprising instructions for the implementation of a method according to claim 1.
